(19) United States
(12) Patent Application Publication
(10) Pub. No.: US 2015/0198733 A1
(43) Pub. Date: Jul. 16, 2015

(54) TRANSDUCER ASSEMBLY

(71) Applicant: TecWel AS, Laksevag (NO)

(72) Inventor: Terje Lenart LIE, Garnes (NO)

(21) Appl. No.: 14/668,958

(22) Filed: Mar. 25, 2015

Related U.S. Application Data
(62) Division of application No. 13/380,757, filed on Mar. 12, 2012, now abandoned.

(51) Int. Cl. G01V 1/52; E21B 47/10

(52) U.S. Cl. CPC G01V 1/52; E21B 47/101

(57) ABSTRACT

A petroleum production well ultrasound logging tool is provided comprising a cylindrical main body having a lower end holding a sideways monitoring transducer assembly comprising a ring-shaped ultrasound transducer array of transducer elements. The transducer array has a downward tapering frustoconical shape. The ultrasound transducer array's radially outward face is covered by a funnel shaped acoustic window with a radially inward facing surface corresponding to the outward face. The ultrasound transducer array and the acoustic window is retained on the cylindrical main body's lower end by an end cap.

### FIELD OF THE INVENTION

The present invention relates to transducer assemblies for use in monitoring systems, for example the invention is concerned with ultrasonic transducer assemblies for monitoring in boreholes in connection with oil and/or gas exploration and/or extraction. Moreover, the present invention is also concerned with methods of monitoring boreholes using such transducer assemblies in connection with oil and/or gas exploration and/or extraction. Furthermore, the present invention also relates to software products for use in implementing these aforesaid methods.

### BACKGROUND OF THE INVENTION

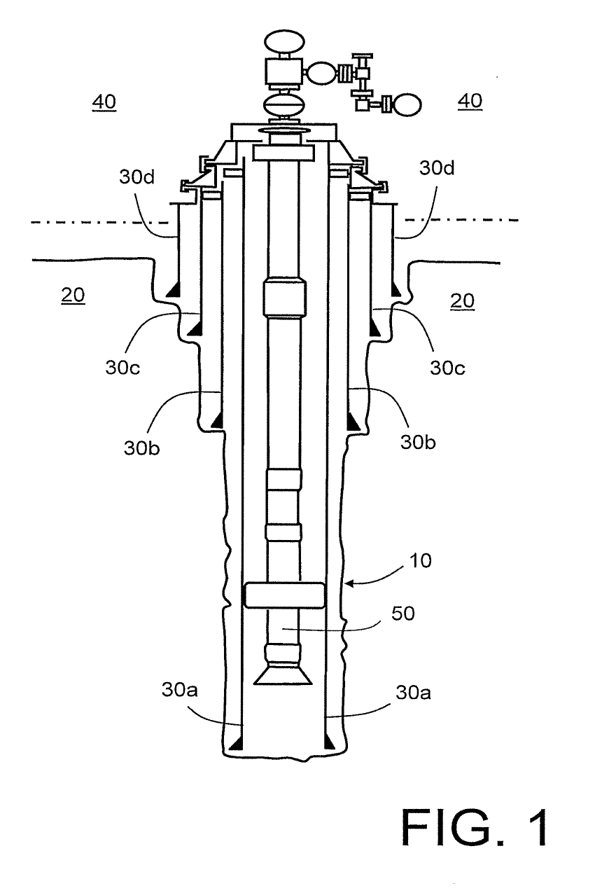

Referring to FIG. 1, a borehole indicated generally by 10 is formed in a region of ground 20 during gas and/or oil exploration. In an event that deposits of oil and/or gas are found substantially at an end of the borehole 10, the borehole 10 provides a route by which the oil and/or gas deposits are subsequently extracted. The borehole 10 is often several kilometres in length and filled with liquid, for example:
(a) with drilling mud when executing boring operations during oil and/or gas exploration; and
(b) with a multiphase mixture of oil, water and sand particles during subsequent oil extraction, namely during production.

In such circumstances, a relatively elevated pressure is often encountered at the and of the borehole 10, for example in an order approaching 1000 Bar. Moreover, on account of geothermal heating in lower strata of the region of ground 20, an ambient temperature within the borehole 10 is susceptible to approaching 150° C. for more. Furthermore, the region of ground 20 is potentially porous and susceptible to fragmenting into quantities of gravel and similar types of sand particles.

In order to successfully drill the borehole 10, it is conventional practice to line the borehole 10 along at least part of its depth with one or more liner tubes 30a, 30b, 30c, 30d; such liner tubes are also often referred to as being “casings”. The liner tubes 30a to 30d are operable, for example, to prevent water and other contaminants penetrating into the borehole 10 at upper regions of the ground 20. For reasons of economy, the borehole 10 is drilled to have a diameter sufficient for accommodating drilling and/or extraction apparatus 50 as well as providing for gas and/or oil extraction; the borehole 10 is not made to be unnecessarily large because drilling time to form the borehole 10 and associated costs would thereby be unnecessarily increased. In practice, the liner tube 30a is conveniently in a range of 150 mm to 500 mm in diameter, more conveniently in an order of 200 mm in diameter.

Many practical problems are often encountered when drilling the borehole 10; moreover, subsequent problems can arise when extracting oil and/or gas via the borehole 10. An example of such problems is that the liner tube 30a develops one or more leakage holes, and/or one or more obstructions. The one or more leakage holes are susceptible to enabling water and sand present in the region of ground 20 to penetrate into a central region of the liner tube 30a; such ingress of sand is susceptible to rendering oil production more costly on account of a need to subsequently remove such sand contamination from extracted oil. Moreover, the liner tube 30a itself is potentially susceptible to becoming obstructed with deposits transported up the liner tube 30a, for example sand/oil/tar deposits. When aforementioned one or more leakage holes and/or obstructions occur many kilometres underground, it is often very difficult to know at an above-ground region 40 what precisely is happening in the ground 20 in respect of the borehole 10. In view of the borehole 10 potentially costing many millions of dollars (US dollars) to drill and prepare for subsequent oil and/or gas extraction, reliable and efficient detection of defects arising in the borehole 10 is of considerable commercial importance. However, physical conditions within the borehole 10, for example in lower regions thereof, are very hostile on account of abrasive sand particles being present, on account of high ambient temperatures in an order of +150° C. or more pertaining, on account of high pressures approaching 1000 Bar pertaining and on account of corrosive and/or penetrative fluids, for example saline water, being present in the borehole 10.

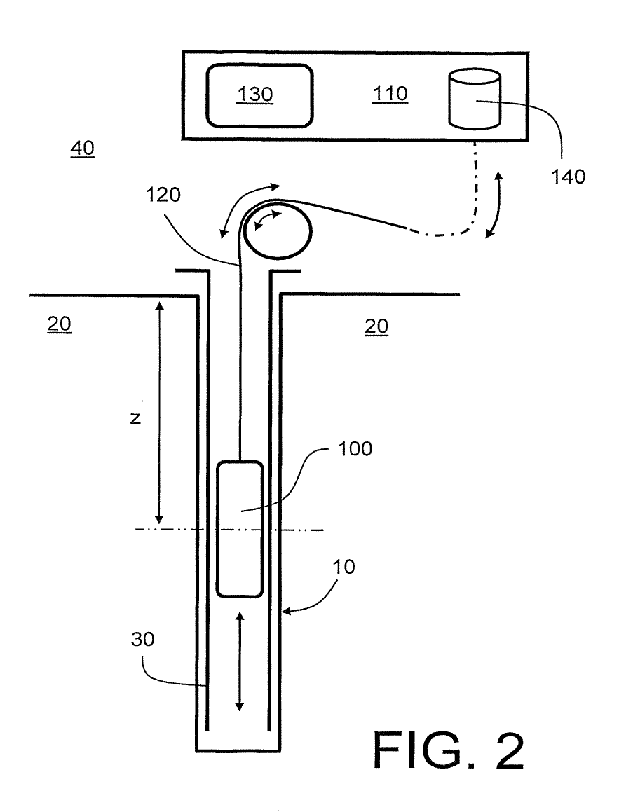

Various types of down-borehole tools are known, for example for measuring multiphase fluid composition within boreholes. Referring to FIG. 2, certain implementations of these tools each comprise a probe assembly 100 operatively inserted into the borehole 10 to be monitored, a data processing arrangement 110 in the above-ground region 40, and a flexible communication link 120 mutually coupling together the data processing arrangement 110 and the probe assembly 100. In operation, the probe assembly 100 senses one or more parameters within the borehole 10, for example phase composition, temperature and/or pressure therein, using one or more sensors to generate one or more sensor signals which are then communicated via the communication link 120 to the data processing arrangement 110. At the data processing arrangement 110, the one or more sensor signals are at least one of: displayed on a display 130 in real-time, recorded in a data memory or data base 140 for subsequent analysis. Implementations of the tools, for example as illustrated in FIG. 2, optionally enable real-time monitoring of boreholes to be achieved. A sliding fluid seal (not shown in FIG. 2) is formed at the top of borehole 10 around a cable implementing the communication link 120 so as to seal the borehole 10 in an event that the borehole 10 is operating under excess pressure, for example as a result the borehole 10 intercepting a gas deposit in the ground 20.

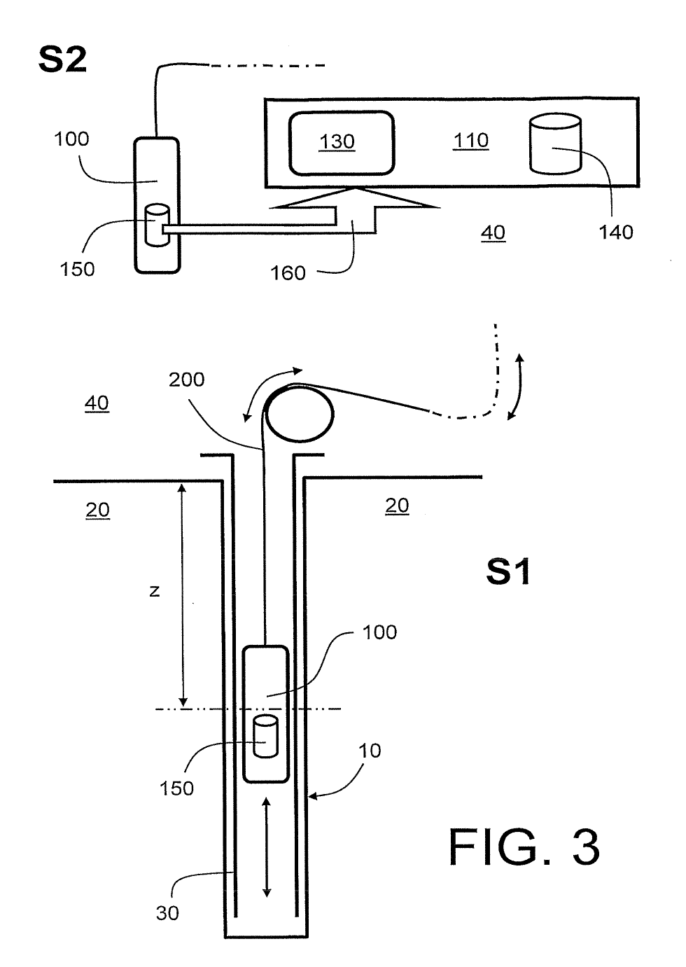

Alternatively, as illustrated in FIG. 3, other implementations of these tools each comprise the probe assembly 100 which additionally includes a semiconductor data memory 150 locally therein for recording signals generated by one or more sensors of the probe assembly 100 in a first step S1 when the probe assembly 100 is employed to characterize the borehole 10. In such an implementation, the probe assembly 100 is operable to function as an autonomous apparatus which is moved substantially blindly within a borehole 10 to collect data therefrom. In a step S2, the probe assembly 100 is then subsequently extracted from the borehole 10 to the above-ground region 40, whereat the probe assembly 100 is coupled to its associated data processing arrangement 110 for downloading monitoring data thereto, as denoted by 160, namely from the data memory 150 of the probe assembly 100 to the data processing arrangement 110.

It is desirable to be able to spatially inspect, in real-time, an inside of the borehole 10 by using the probe assembly 100. On detection of a defect such as a leakage hole or obstruction, it is desirable for the probe assembly 100 to be maintained in a locality of the defect for a longer period to sample an enhanced amount of data, thereby enabling the defect to be identified and characterized to a greater degree of certainty. Such operation requires that probe assembly 100 to be provided with robust and durable sensors which are operable to withstand hostile conditions present in the borehole 10 whilst simultaneously providing a relative high quality of spatial monitoring. By identifying and characterizing one or more defects and/or obstructions to a greater degree of certainty by such high quality monitoring, repair or mitigation of the one or more defects and/or obstructions are susceptible to being implemented in a more efficient and selective manner.

A technical problem which the present invention therefore addresses is providing transducer assemblies which are more appropriate to employ within boreholes when monitoring and characterising one or more defects and/or obstructions occurring within the boreholes.

### SUMMARY OF THE INVENTION

An object of the present invention is to provide an improved transducer assembly which is operable to provide in-borehole sideways monitoring and/or down-borehole monitoring.

According to a first aspect of the invention, there is provided a transducer assembly as claimed in appended claim 1: there is provided a transducer assembly for monitoring within a borehole, the transducer assembly being operable to at least one of:
(a) generate acoustic radiation when excited with one or more signals; and
(b) generate one or more signals when acoustic radiation is received thereat;
   wherein the transducer assembly includes one or more piezo-electric elements for converting between acoustic radiation and corresponding signals, characterized in that
(c) the assembly includes an interfacing member for acoustically interfacing between the one or more piezo-electric elements and an environment of the borehole for protecting the one or more piezo-electric elements from the environment; and
(d) the assembly is adapted to at least one of generate acoustic radiation and sense acoustic radiation in a sideways or down-borehole direction.

The invention is of advantage in that transducer array is capable of providing more effective monitoring in sideways directions within a borehole and/or down the borehole.

Optionally, in the transducer assembly, the interfacing member is formed to have at least one of following profiles: an annular shell, an acoustic lens.

Optionally, the assembly includes an acoustic isolation feature to resist propagation of radiation therethrough. Such an isolation feature is beneficially in enabling the transducer assembly to provide more representative spatial images of a region within the borehole.

Optionally, the transducer assembly is adapted for use in a system for monitoring within a borehole, the system comprising a probe assembly operable to be moved within the borehole for sensing one or more physical parameters therein, a data processing arrangement being located outside the borehole, and a data communication arrangement operable to convey sensor data indicative of the one or more physical parameters from the probe assembly to the data processing arrangement for subsequent processing and display and/or recording in data memory,

wherein
(a) the probe assembly includes one or more sensors including the transducer assembly for spatially monitoring within the borehole and generating corresponding sensor signals;
(b) the probe assembly includes a digital signal processor for executing preliminary processing of the sensor signals to generate corresponding intermediately processed signals for communication via the data communication arrangement to the data processing arrangement; and
(c) the data processing arrangement is operable to receive the intermediately processed signals and to perform further processing on the intermediately processed signals to generate output data for presentation and/or for recording in a data memory arrangement.

Optionally, when using the transducer assembly within the system, the system is operable to generate the output data for presentation in real-time when the probe assembly is moved within the borehole.

Optionally, when using the transducer assembly within the system, the system is operable in at least one of first and second modes, wherein:
(a) the first mode results in the system passively sensing noise sources present in the borehole generating radiation for sensing at the one or more sensors; and
(b) the second mode results in the system actively emitting radiation into the borehole and receiving at the one or more sensors corresponding reflected radiation from a region in and/or around the borehole for generating the sensor signals.

Optionally, the system is operable to be dynamically reconfigurable between the first and second modes when the probe assembly is being moved in operation within the borehole.

Optionally, when using the transducer assembly in the system, the system is operable to communicate data bi-directionally between the data processing arrangement and the probe assembly, wherein the digital signal processor of the probe assembly is operable to being reconfigured between a first function of general sensing around in a region of the borehole in a vicinity of the probe assembly, and a second function of specific sensing in a sub-region of the region of the borehole in a vicinity of the probe assembly.

Optionally, when using the transducer assembly within the system, the data communication link is implemented using one or more twisted-wire pairs including material insulation and copper electric conductors embedded within the material, the data communication link being clad by cladding susceptible to bearing a weight of the probe assembly when the assembly is moved in operation within the borehole. More optionally, the material insulation includes a plastics material insulation.

According to a second aspect of the invention, there is provided a method as claimed in appended claim 12: there is provided a method of sensing within a borehole in a sideways direction or a down-borehole direction using a transducer assembly pursuant to the first aspect of the invention, the method comprising steps of:
(a) applying one or more signals to one or more piezo-electric elements of the transducer assembly;
(b) exciting acoustic radiation at the transducer assembly for propagating within the borehole;
(c) receiving at the transducer array a portion of the radiation in step (b) which is reflected from one or more features associated with the borehole;
(d) transducing the portion of the radiation to generate corresponding one or more received signals; and
(e) processing the one or more received signals for subsequent presentation on a display and/or for storage in data memory.

According to a third aspect of the invention, there is provided a software product stored on a data processor, the product being executable on computing hardware for implementing a method pursuant to the second aspect of the invention.

According to a fourth aspect of the invention, there is provided a probe assembly for monitoring within a borehole, the probe assembly including a transducer assembly pursuant to the first aspect of the invention, the probe assembly including a digital signal processing arrangement within the probe for providing local intermediate processing of the one or more signals.

Features of the invention are susceptible to being combined in any combination without departing from the scope of the invention as defined by the appended claims.

### DESCRIPTION OF THE DIAGRAMS

Embodiments of the present invention will now be described, by way of example only, with reference to the following diagrams wherein:

FIG. 1 is an illustration of a borehole furnished with a liner tube arrangement, also known as a casing;

FIG. 2 is a schematic illustration of a down-borehole probe arrangement for sensing physical parameters within a borehole and generating corresponding signals for communicating in real-time to a data processing arrangement remote from the borehole;

FIG. 3 is a schematic illustration of a down-borehole probe arrangement for sensing physical parameters within a borehole and generating corresponding signals for data-logging locally within a probe assembly, for subsequent down-loading to a data processing arrangement when the probe assembly has been extracted from the borehole;

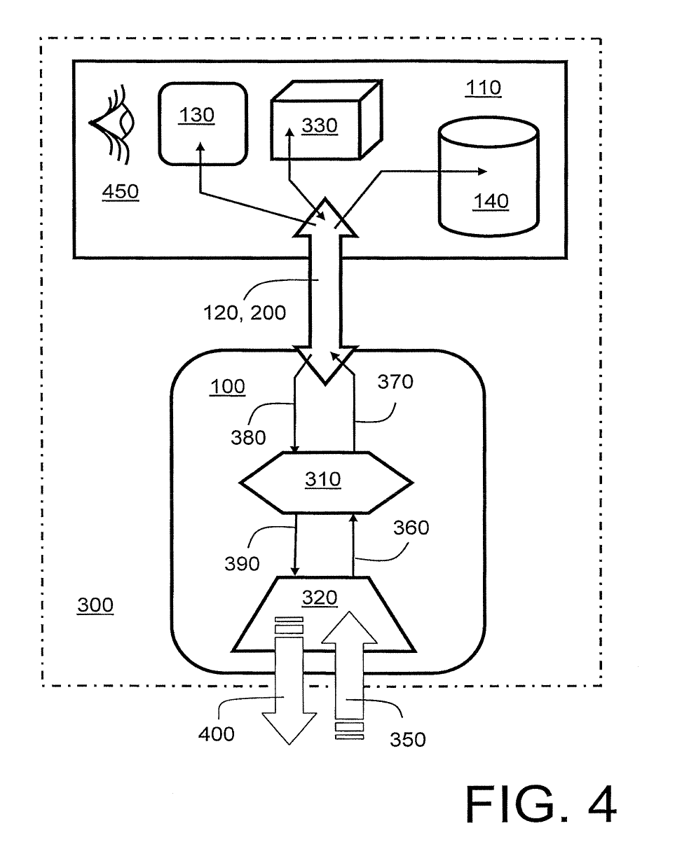

FIG. 4 is a schematic illustration of a monitoring system for monitoring down boreholes, the system including an ultrasonic transducer assembly pursuant to the present invention;

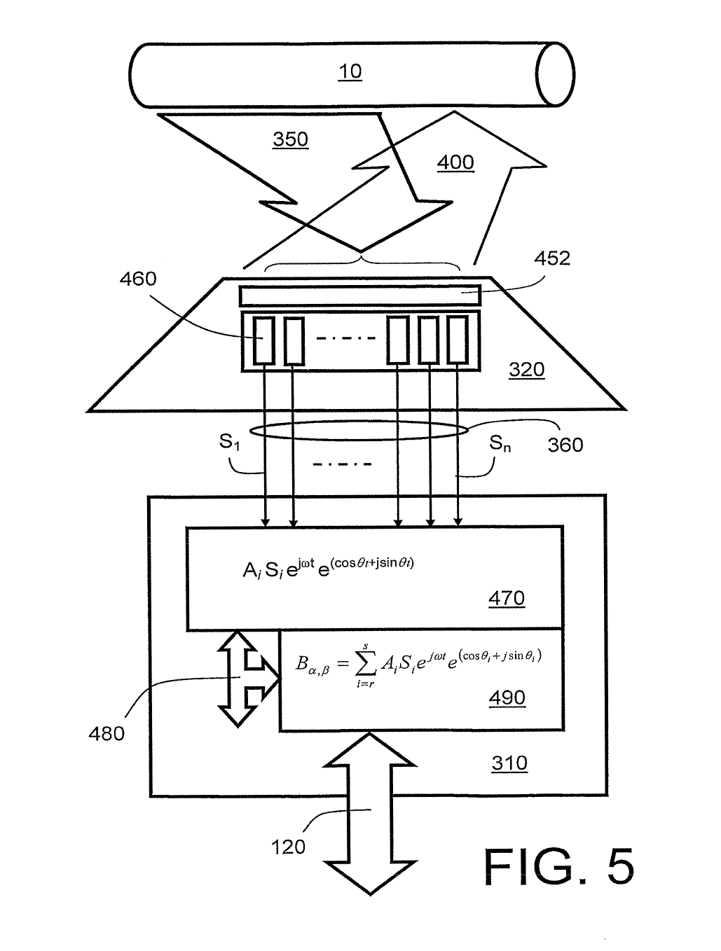

FIG. 5 is a more detailed illustration of component parts of the system in FIG. 4, the components including an ultrasonic transducer assembly pursuant to the present invention for receiving ultrasonic radiation from boreholes, and optionally for also interrogating such boreholes;

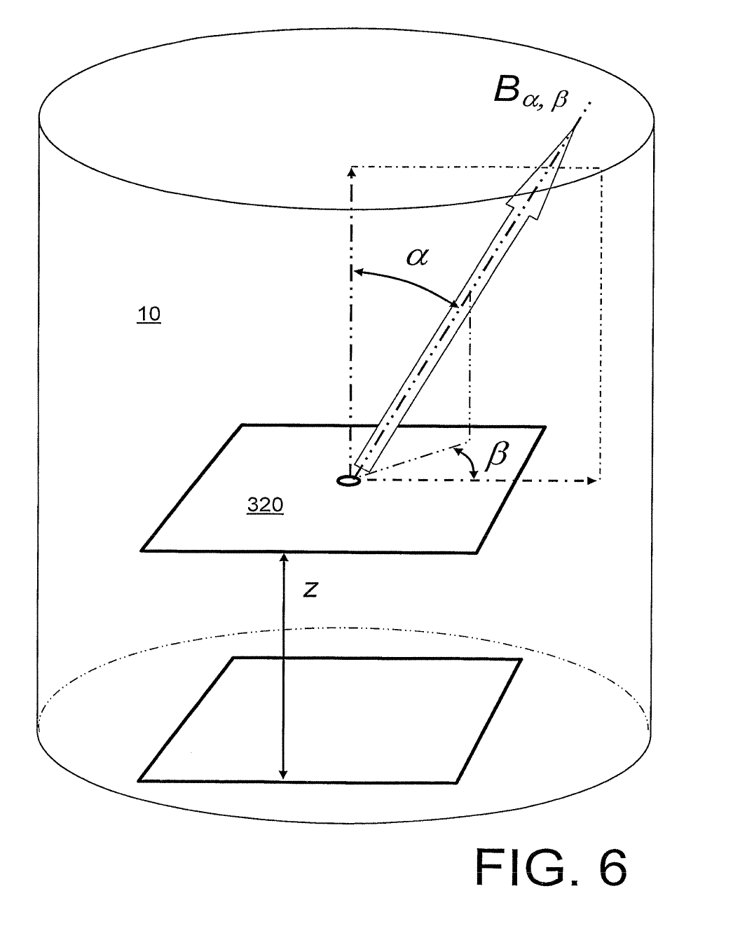

FIG. 6 is an illustration of polar sensing angles of the transducer array of FIG. 5;

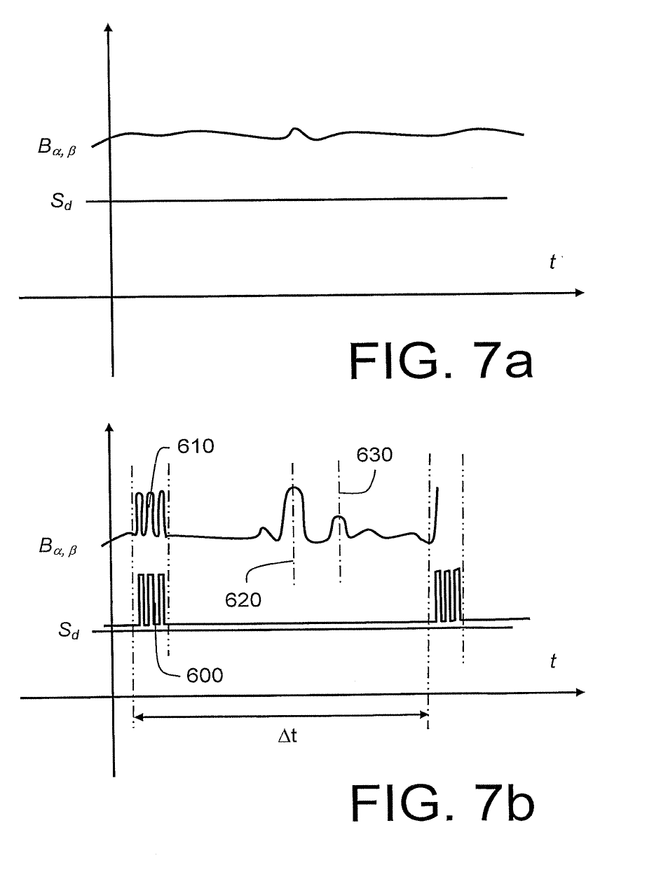

FIGS. 7a and 7b are illustrations of signals present in the system of FIG. 4 when in operation;

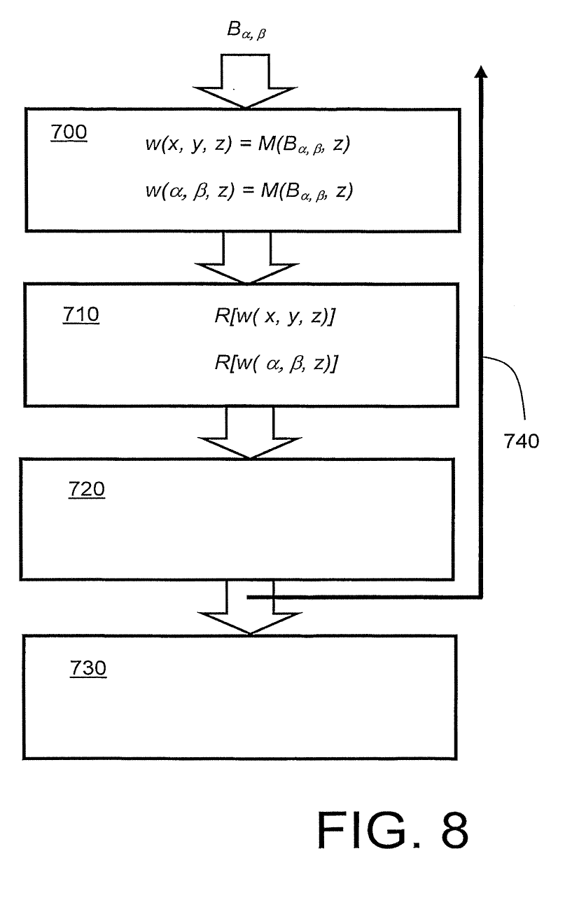

FIG. 8 is a flow diagram of signal processing operations executed within the system of FIG. 4;

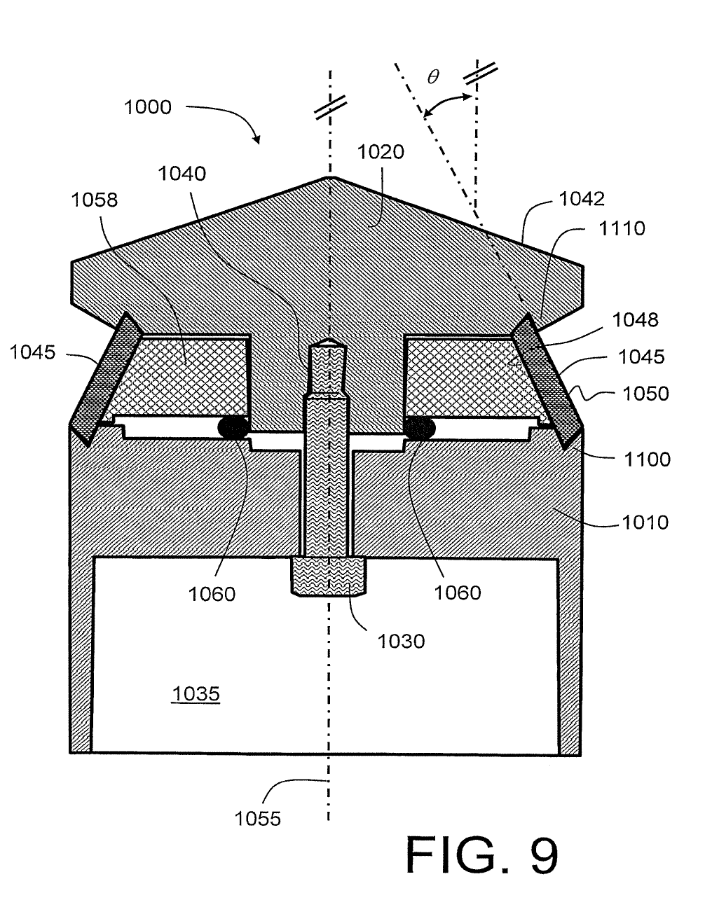

FIG. 9 is an illustration of a first transducer assembly pursuant to the present invention for use with the systems as illustrated in FIGS. 2 to 4;

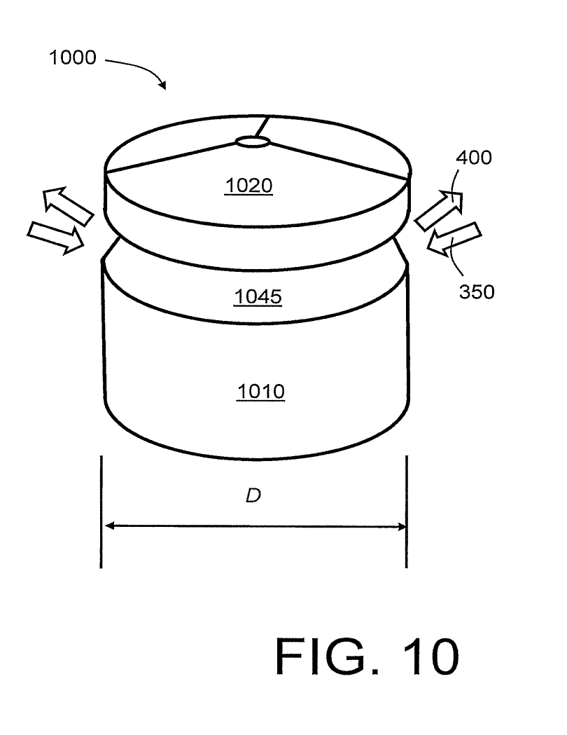

FIG. 10 is an external view of the first transducer assembly of FIG. 9; and

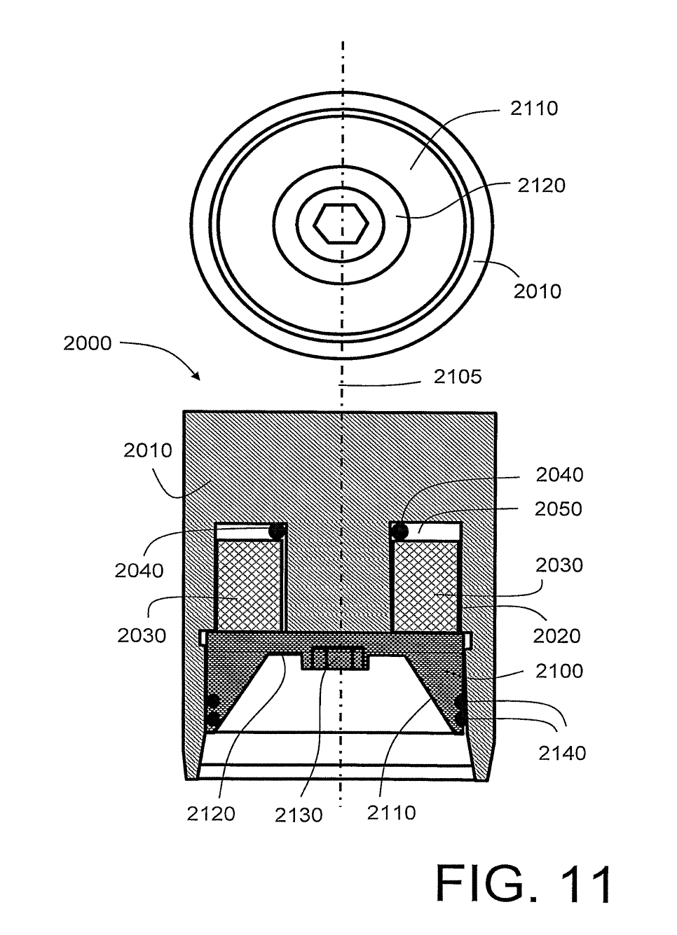

FIG. 11 is an illustration of a second transducer assembly pursuant to the present Invention for use with the systems as illustrated in FIGS. 2 to 4.

### DESCRIPTION OF EMBODIMENTS OF THE INVENTION

The present invention is concerned with transducer assemblies which are susceptible to being used in the systems illustrated in FIGS. 2 and 3. In overview, the systems illustrated in FIGS. 2 and 3 include:
(a) a probe assembly 100 for spatially sensing within a borehole 10;
(b) a communication arrangement, for example the data communication link 120 or the data memory 150, for communicating elsewhere signals acquired by the probe assembly 100; and
(c) a data processing arrangement 110 in communication via the aforesaid communication arrangement to the probe assembly 100.

The probe assembly 100, the communication arrangement implemented as the data communication link 120 and the data processing arrangement 110 constitute a system as denoted by 300 in FIG. 4. The probe assembly 100 includes one or more transducer arrays 320 coupled via a digital signal processor (DSP) 310 and then via the communication link 120 to the data processing arrangement 110. Moreover, the data processing arrangement 110 includes a data processor 330 which is operable to receive data from the probe assembly 100 via the communication link 120; the data processor 330 is also operable to send control commands via the communication link 120 to reconfigure the digital signal processor (DSP) 330 in response to signals generated in operation by the one or more transducer arrays 320.

The system 300 is optionally susceptible to operating in a first passive mode and in a second active mode.

In the first passive mode, physical signals 350 that are generated by ambient processes occurring in and around the borehole 10 propagate within the borehole 10 and are eventually received by the one or more transducer arrays 320. The one or more transducer arrays 320 generate corresponding electrical signals 360 which are conveyed to the digital signal processor (DSP) 310. Thereafter, the digital signal processor 310 performs primary processing of the electrical signals 360 to generate corresponding intermediate processed signals 370 which are communicated via the communication link 120 to the data processor 330 and/or stored in the memory 150. The data processor 330 then performs secondary processing on the intermediate processed signals 370 to generate corresponding output data. Moreover, the data processor 330 is optionally operable to store at least part of the intermediate processed signals 370 in the data memory 140. Moreover, the data processor 330 is optionally operable to store at least part of the output data in the data memory 140. Moreover, the data processor 330 is operable to present the output data on the display 130.

In the second active mode, the data processor 330 is operable to send control signals 380 to the digital signal processor (DSP) 310 to drive at least one of the one or more transducer arrays 320 with one or more drive signals 390 to cause the at least one transducer array 320 to emit radiation 400 into the borehole 10. Optionally, the emitted radiation 400 is pulsed radiation comprising pulses punctuated by quiet periods; portions of the radiation 400 reflected from structures within and in near proximity to the borehole 10 are received back at the one or more transducer array 320 as the physical signals 350 to generate the corresponding electrical signals 360 which are subsequently processed in the digital signal processor 310 to subsequently generate the intermediate processed signals 370. The data processor 330 then performs secondary processing of the intermediate processed signals 370 to generate corresponding output data. Moreover, the data processor 330 is optionally operable to store at least part of the intermediate processed signals 370 in the data memory 140. Moreover, the data processor 330 is optionally operable to store at least part of the output data in the data memory 140. Moreover, the data processor 330 is operable to present the output data on the display 130.

The system 300 is optionally designed to be able to switch dynamically between the aforementioned first passive mode and second active mode. Alternatively, the system 300 is optionally designed to function only in the first passive mode, for example optimized, to function in the first passive mode. Yet alternatively, the system 300 is optionally designed to function only in the second active mode, for example optimized to function in the second active mode.

It will be appreciated from the foregoing that the system 300 is operable to distribute data processing activities between the digital signal processor 310 and the data processor 330.

Such a distribution of data processing activities is of benefit in that data reduction within the probe assembly 100 is feasible to achieve so that available bandwidth of the communication link 120 is not occupied by data which bears relatively irrelevant information; in the system in FIG. 2, such data reduction is beneficially also employed to reduce a quantity of data to be stored in the data memory 150. By such data reduction in the system 300, for example achieved by various data compression techniques which will be described in more detail later, it becomes feasible to provide real-time images of the borehole 10 on the display 130 at a sampling rate which is practical for the probe assembly 100 to be moved at an acceptably fast velocity up or down the borehole 10 for investigating defects and/or obstructions therein or in a vicinity thereof. When the borehole 10 is many kilometres in length, an inspection rate when using the system 300 beneficially corresponds to several metres per second along the borehole 10.

The system 300 has been described in overview in the foregoing. However, before describing component parts of the system 300 in greater detail, other issues regarding the probe assembly 100 will next be elucidated. The borehole 10 is often at a pressure P which, in certain circumstances, can approach 1000 Bar. For example, the borehole 10 can often be many kilometres deep and filled with water, or with an abrasive multiphase mixture including oil, water and sand particles. When the probe assembly 100 is lowered into the borehole 10 filled with liquid to a depth of a kilometre or more, the pressure P acting upon the probe assembly 100 is potentially enormous. In such circumstances, a leakage hole in the liner tube 30a with many Bar differential pressure between a first region outside the liner tube 30a to a second region inside the liner tube 10 potentially results in a considerable flow of fluid between the first and second regions causing turbulent generation of acoustic radiation from a vicinity of the leakage hole. It is also feasible in certain situations that the borehole 10 is filled with gas at a high pressure approaching 1000 Bar on account of the borehole 10 intercepting a gas reservoir. Such high pressures in the borehole 10 risk forcing gas or liquid to ingress into an inside region of the probe assembly 100 and can also force gas into a polymeric material from which the cladding 200 is fabricated. For example, if the cladding fabricated from polymeric material is suddenly depressurized from a high pressure of 1000 Bar pressure to nominal atmospheric pressure of 1 Bar (760 mm Hg), gas forced by such a high pressure to earlier ingress into interstitial spaces within the polymeric material is susceptible to cause the polymeric material to expand to form a foam-like material with microvoids therein, potentially resulting in permanent damage to the polymeric material. Optionally, as illustrated in FIG. 1, the inner liner tube 30a includes a sliding seal around a top region thereof as illustrated in FIG. 1 when the borehole 10 is required in operation to exhibit an elevated pressure relative to ambient atmospheric pressure of nominally substantially 1 Bar (760 mm Hg). Thus, the seal is beneficially adapted to be capable of sealing around the cladding 200 when the probe assembly 100 is deployed within the borehole 10. Although a use of a polymeric material to form the cladding 200 to clad the communication link 120 is virtually unavoidable, a casing of the probe assembly 100 is beneficially fabricated from a robust material which is resistant to abrasion and corrosion, for example fabricated from machined solid stainless steel material or seamless stainless steel tubing.

The one or more transducer arrays 320 are beneficially implemented as an array of one or more piezo-electric elements, for example fabricated from lead zirconate titanate (PZT) or similar strongly piezo-electric material. Optionally, the piezo-electric material is polarized during manufacture, for example by applying high potential pulses to electrodes formed on the piezo-electric material. In operation, the one or more transducer arrays 320 are susceptible to being excited by the one or more drive signals 390 applied thereto to generate the radiation 400 as ultrasonic radiation, and also susceptible to receive the radiation 350 as reflected ultrasonic radiation for generating aforesaid electrical signals 360. Piezo-electric material of the one or more transducer arrays 320 is optionally directly in physical contact with fluid present within the borehole 10 in order to obtain most efficient coupling of ultrasonic radiation. Alternatively, the transducer 320 is operable to communicate with the interior region of the borehole 10 via one or more interfacing windows. As will be elucidated in greater detail later, the interfacing windows are beneficially specially profiled to form acoustic lenses, for example by molding or by precision machining processes. Ceramic materials such as alumina, silicon carbide, silicon nitride or zirconates can optionally be employed to form the one or more interfacing windows.

On account of the borehole 10 being potentially heated up to a temperature T approaching +150° C. by geothermal energy in rock formations surrounding the borehole 10, there is a potentially severe limitation regarding power dissipation which can occur within the probe assembly 100 when in operation. When the probe assembly 100 is operating pursuant to the aforesaid second active mode, generating the one or more drive signals 390 in drive amplifiers is susceptible to resulting in electrical power dissipation within the probe assembly 100. Moreover, data processing occurring in operation in the digital signal processor (DSP) 310 is susceptible to causing additional dissipation in both the first passive mode and in the second active mode.

Optionally, the digital signal processor (DSP) 310 is provided with a Peltier cooling element for optionally cooling the signal processor 310; however, use of the Peltier cooling element is susceptible to adding to a total dissipation occurring within the probe assembly 100 and is therefore only employed selectively when effective cooling of the processor 310 is susceptible to being achieved. The digital signal processor (DSP) 310 is beneficially implemented using semiconductor devices based upon CMOS technology which are not vulnerable to thermal runaway as a result of increase in minority-carrier currents therein during operation. Similarly, the drive amplifiers employed within the probe assembly 100 to provide the one or more drive signals 390 are beneficially also based upon MOSFET devices which are capable of operating at elevated temperatures approaching +200° C. without suffering thermal runaway. The digital signal processor (DSP) 310 is beneficially implemented as a plurality of integrated circuits so that heat dissipation is spatially distributed over several integrated circuit devices rather than being concentrated in any one single integrated circuit device. Optionally, the digital signal processor (DSP) 310 is implemented as a single integrated circuit mounted on a low thermal-resistance mount, for example a copper or aluminium mount, having a thermal resistance of less than 0.5° C./Watt, and more preferably less than 0.2° C./Watt relative to a general ambient temperature within the probe assembly 100.

On account of the liner tube 30a having an inside diameter in an order of 200 mm, the probe assembly 100 is conveniently manufactured to have a diameter in a range of 100 mm to 180 mm, more preferably to have a diameter of substantially 150 mm. Moreover, the cladding 200 of the communication link 120 is optionally required to be strong enough to bear a weight of the probe assembly 100 when lowered kilometres down the borehole 10 including a weight of the cladding 200 itself; alternatively, or additionally, one or more mechanical supporting elements, for example one or more high-tensile steel ropes, are optionally employed to bear a weight of the probe assembly 100 when deployed in the borehole 10. If the cladding 200 is relatively larger in diameter, for example 25 mm or greater in diameter, it becomes too massive and is difficult to bend around pulleys of feed hoists above the borehole 10. Conversely, if the cladding 200 is relatively small in diameter, for example 4 mm or smaller in diameter, the cladding 200 is susceptible to becoming snarled on projections forming in operation on an inside-facing surface of the borehole 10, or on the liner tube 30a as appropriate, and is potentially unable to reliably bear its own weight and also the weight of the probe assembly 100. In practice, with modern advanced cladding materials, for example by using one or more of carbon fibres. Kevlar and advanced nano-material fibres, it is feasible to provide sufficient robustness for the cladding 200 when the cladding has a diameter in a range 5 mm to 15 mm, more preferably in a range of 6 mm to 10 mm, and most preferably substantially 8 mm.

In operation, the cladding 200 is susceptible to exhibiting strain when a stress arising from weight is applied thereto. Optical fibres are not robust to stretching and can be fractured when undergoing even modest longitudinal strain. In consequence, the communication link 120 is conveniently implemented to include one or more electrical twisted pairs of wires. The wires each include plastics material insulation which is capable of stretching under stress. Moreover, each wire includes copper conductors therein; copper is a ductile metal of relatively low weight, of high electrical conductivity, of relatively high resistance to oxidative corrosion, and is less prone to work-hardening when subjected to repeated bending cycles in comparison to other metals. At each end of the communication link 120 are included Ethernet line drivers and receivers matched to a transmission-line impedance of the one or more twisted-wire pairs of the communication link 120; data is thereby bi-directionally communicated in operation along the communication link 120 which is capable of enabling a data flow of several hundred kilobytes (kbytes) per second to be supported. It is however to be bourn in mind that conventional real-time streaming of two-dimensional video images often requires a communication bandwidth in the order of MHz.

The data processing arrangement 110 is implemented as a configuration of proprietary components and is susceptible to being installed on-land, on a sea-going vessel, in a submarine, on an oil exploration platform, or on an air-borne vehicle via an additional wireless link. The data processor 330 and the display 130 are beneficially implemented using proprietary computing hardware; the data processor 330 beneficially has a data entry device, for example a keyboard and a computer tracker-ball mouse, for enabling one or more users 450 to control operation of the system 300 in real-time. The data processor 330 is coupled in communication with the data memory 140 which is conveniently implemented by using at least one of: semiconductor memory, optical data memory, magnetic data memory.

Operation of the system 300 will now be described in greater detail.

During exploratory drilling activities for gas and/or oil, expensive and complex equipment is used under the supervision of experienced technical staff. In consequence, drilling and lining the borehole 10 with the liner tubes 30 is an extremely expensive activity, for example often costing in a region of a million United States dollars per day. When such high costs are encountered, problems occurring within the borehole 10 need to be identified quickly and resolved promptly. Even an operation of removing a drill bit and its associated string from the borehole 10 is a major undertaking, in some cases corresponding to several days of expensive work. When applied to monitor the borehole 10, for example after removal of a drill bit and associated drive string therefrom, the system 300 needs to be highly reliable, susceptible to being rapidly deployed into the borehole 10, and to provide flexibility in use by way of real-time monitoring to avoid a need to repeatedly reinsert the probe assembly 100 into the borehole 10, for example in the liner tube 30a, when performing metrology thereon and monitoring thereof.

Referring to FIG. 5, the probe assembly 100 includes one or more transducer arrays 320. Each transducer array 320 comprises an assembly of one or more piezo-electric transducer elements 460 operable to at least receive ultrasonic radiation denoted by the radiation 350 from the borehole 10 and its environs; there are n transducer elements in the transducer array 320. As elucidated in the foregoing, the radiation 350 is generated by one or more processes occurring in the borehole 10 when the system 300 is operating in the first passive mode, and is generated by reflection of the radiation 400 when the system 300 is operating in the aforesaid second active mode. As described earlier, the one or more transducer elements 460 optionally acoustically communicate via an interfacing member 452 which efficiently transmits acoustic radiation therethrough, for example ultrasonic radiation therethrough, as well as protects the transducer elements 460 from a harsh environment within the borehole 10. The interfacing member 452 is optionally formed or machined to provide a lens-like action in operation for assisting in spatially defining the radiation 400 into a spatially well-defined beam. Similarly, the interfacing member 452 is similarly operable to help define a direction in which the one or more arrays 320 are preferentially sensitive in operation when receiving the radiation 350.

The one or more transducer elements 460 in each of the one or more transducer arrays 320 are operable to generate signals Sᵢ e^{jωt} wherein i is in a range of 1 to n; the signals Sᵢ correspond to the electrical signals 360 described earlier. Beneficially, one or more of the transducer elements 460 are operable to emit and/or receive ultrasonic radiation having a frequency in a range of 500 kHz to 5 MHz when the system is operating pursuant to the second active mode. Conversely, one or more of the transducer elements 460 are operable to receive ultrasonic radiation having a frequency in a range of a few hundred Hz to several hundred kHz when the system 300 is functioning in the first passive mode, depending on which type of monitoring is to be performed within the borehole 10; for example, sand particles impacting onto a housing of the probe assembly 100 when operating in the first mode result in acoustic signals being generated which are in a frequency range characteristic of impacting sand particles, namely considerably lower than a frequency of 500 kHz. The digital signal processor 310 is operable to condition one or more of the signals Sᵢ for example in a manner of a phased array algorithm to steer a direction of greatest sensitivity of the transducer array 320. Such steering is achieved by performing two principal steps in the digital signal processor 310 as will now be described.

The first step of beam forming involves selectively phase shifting and scaling the signals Sᵢ under control of various control parameters. Moreover, the first step is performed in computing hardware of the digital signal processor 310 operable to execute a software product stored on a data carrier, for example the data carrier being a non-volatile semiconductor data memory associated with the digital signal processor 310. Alternatively, or additionally, the software is dynamically downloaded to random-access-memory (RAM) associated with the digital signal processor 310 for enabling the digital signal processor 310 to be reconfigured when in operation within the borehole 10. In the first step, the signals Sᵢ are subject to scaling and phase shifting operations as defined by Equation 1 (Eq. 1) to generate corresponding intermediate processed signals Hᵢ;

Hᵢ=AᵢSᵢe^{jωt}e^{cos θ}^{ᵢ}^{+j sin θ}^{ᵢ} Eq. 1

wherein
j=square route of −1;
ω=angular frequency of signal component of interest;
t=time;
θᵢ=phase shift applied for beam forming purposes;
Aᵢ=scaling coefficient for beam forming purposes.

Optionally, phase-shifting is achievable by using digital delay lines, beneficially implemented using data memory devices, for example as in clocked first-in first-out (FIFOs) registers.

The second step of beam forming is achieved by selectively summing one or more of the intermediate processed signals Hᵢ as defined by Equation 2 (Eq. 2) to generate corresponding signals B_{α,β} representative of a component of radiation received at the transducer array 320 from a specific direction as follows:

$${B}_{α , β} = {\sum }_{i = r}^{s} {H}_{i} \qquad Eq . 2$$

wherein
α, β=angles define the specific direction, relative to an orientation of the transducer array 320, in which the transducer array 320 is preferentially sensitive for generating the signal B_{α, β}; and
r, s=index values defining which intermediate signals Hᵢ to be selectively summed to generate the signal B_{α, β}.

The signals Hᵢ to be summed optionally do not necessarily need to lie consecutively in series of index value i; for example appropriate scaled and phase-shifted signals Sᵢ for i=1, 10, 12, 15 can be selectively combined to generate the signal B_{α, β}. The angles α and β are susceptible to being defined, for example, as illustrated in FIG. 6. A mathematic mapping relates the angles α, β to corresponding phase shift θᵢ and scaling coefficient Aᵢ are denoted by function G in Equation 3 (Eq. 3):

(θ,A)=G(α,β) Eq. 3

wherein the function G is determined by a geometry and configuration of the one or more transducer arrays 320 employed. The function G is optionally pre-computed and stored as a mapping in data memory, for example in a form of a look-up table; the look-up table is beneficially stored in at least one of the data processing arrangement 110 and the digital signal processor 310. Alternatively, the function G can be computed in real-time from parameters in at least one of the data processing arrangement 110 and the digital signal processor 310.

The signals B_{α, β} are computed using at least Equations 1 and 2 (Eqs. 1 and 2) in real-time and then communicated from the digital signal processor 310 via the communication link 120 to the data processor arrangement 110 for further processing there. Optionally, for example under control from the data processing arrangement 110 communicated via the communication link 120 to the probe assembly 100, the signals Sᵢ are communicated directly in real-time, namely directly streamed, in a substantially unprocessed state via the communication link 120 to the data processing arrangement 110 and a majority of data processing then performed in the data processing arrangement 110.

As elucidated in the foregoing, the system 300 is designed to economize on away in which an available bandwidth of the communication link 120 is utilized in operation; in a similar manner, with reference to FIG. 3, it is beneficial to utilize data storage capacity of the data memory 150 in a most efficient manner. Data flow reduction is susceptible to being achieved by one or more of following approaches:
(a) by dynamically instructing the probe assembly 100 only to send, alternatively record in the data memory 150, the signals Sᵢ or the signals B_{α, β} corresponding to radially directions defined by B_{α, β} of special interest, thereby avoiding to process and send data for directions which are not of interest;
(b) by dynamically instructing the digital signal processor 310 only to process signals from a subset of the transducer elements 460, corresponding to a reduction in angular and spatial resolution, for example by dynamically adjusting values for limit indexes r, s; this saves computing effort and power dissipation within the probe assembly 100;
(c) by dynamically instructing the digital signal processor 310 to send, alternatively store in the data memory 150, the signals corresponding to B_{α, β} or Sᵢ at a reduced resolution, for example by only sending more significant bits of data bytes whilst maintaining computational accuracy within the digital signal processor 310; and
(d) by performing a fast Fourier transform (FFT) at the digital signal processor 310 of the signal B_{α,β} to generate corresponding Fourier spectral coefficients F_{α, β} and then by communicating the spectral coefficients F_{α, β} via the communication link 120 to the data processing arrangement 110, namely by adopting a parameterized data compression process.

Optionally, in approach (d), the digital signal processor 310 is operable to compare, for example by a correlation-type technique or by using a neural network approach, the Fourier spectral coefficients F_{α, β} with templates of frequency spectra of specific types of known defects and/or obstructions occurring within boreholes, for example leakage holes, oil/tar/sand clumps, cracks and so forth. In an event of the computer frequency spectrum F_{α, β} being sufficiently similar, within a threshold limit, to one or more of the frequency spectra of the one or more templates, a defect and/or obstruction in the borehole 10 is deemed to have been found; in such case of finding a defect and/or obstruction for the angles α, β, the digital signal processor 310 is operable to simply send an identification that one or more defects and/or obstructions have been detected and a nature of the one or more detected defects and/or obstructions. Such an extension of the approach (d) represents considerable data processing in the probe assembly 100 but also provides a very high degree of data compression which potentially enables, for a given bandwidth available in the communication link 120 or data storage capacity in the data memory 150, the probe assembly 100 to be advanced at a greater longitudinal velocity along the borehole 10 whilst providing monitoring. In an event that the borehole 10 is mostly free of defects and/or obstructions along its length, such an approach as in (d) results in a relatively smaller amount of data exchange along the communication link 120 until a defect and/or obstruction is found; in such an event that a defect and/or obstruction is found, the system 300 is, for example, capable of dynamically switching from the approach as in (d) to comprehensive sampling of the signal B_{α, β} when the probe assembly 100 is in close proximity to the detected defect and/or obstruction and whilst the probe assembly 100 is maneuvered more slowly relative to the detected defect and/or obstruction.

When the system 300 is operated in the first passive mode, a signal B_{α, β} as illustrated in FIG. 7a is often obtained. In FIG. 7a, there is an absence of any drive signal S_{d} 390 applied to the one or more transducer arrays 320; such absence is denoted by a horizontal line in FIG. 7a. Noise generated within the borehole 10 is received at the one or more transducer arrays 320 and gives rise, for example, to a resolved noise-like chaotic signal as illustrated in FIG. 7a.

Conversely, when the system 300 is operated in the second active mode, at least one of the transducer arrays 320 is driven with the one or more drive signals S_{d} 390 which are optionally phase shifted and amplitude adjusted so that the one or more transducer arrays 320 emit a beam of ultrasonic radiation in a preferred direction; such steering of the beam is potentially further enhanced when the aforementioned interfacing member 452 is included. Alternatively, the transducer array 320 is driven with the one or more signals S_{d} 390 to emit ultrasonic radiation more omni-directionally from the one or more transducer arrays 320. The one or more drive signals S_{d} 390 optionally include a temporal sequence of single excitation pulses mutually separated by a time duration Δt; such excitation single pulses approximate to pseudo-Dirac pulses and excite a natural mode of resonance of the transducer array 320 such that the radiation 400 is emitted at a frequency of this natural mode of resonance; such a natural frequency of resonance is potentially, for certain Eigenmodes of resonance of the one or more transducers 460, in an order of 500 kHz to 5 MHz, more optionally substantially 3.5 MHz. Conversely, when the drive signal S_{d} 390 is a periodically repeated sequence of a burst of pulses 600 as illustrated in FIG. 7b, the frequency of the radiation 400 is susceptible to being at least partially defined by a pulse repetition frequency within the burst of pulses 600.

When operating in the second active mode, the burst of pulses 600 results in instantaneous direct signal breakthrough coupling, for example by way of direct electrostatic and/or electromagnetic coupling, giving rise to an initial detected pulse 610 which, optionally, can be gated out using the digital signal processor 310. A pulse wavefront in the radiation 400 propagates from the transducer array 320 to an inside facing surface of the liner tube 30a wherefrom a portion of the radiation 400 is reflected and propagates as a component of the radiation 350 back to the transducer array 320 to give rise to a reflected pulse 620 as shown in FIG. 7b in the resolved signal B_{α, β}. A proportion of the radiation 400 is further coupled into the liner tube 30a and is reflected from an exterior facing surface of the liner tube 30a back through the liner tube 30a and further as another component of the radiation 350 back to the transducer array 320 to give rise after resolving to a weaker pulse 630 as shown in FIG. 7b in the resolved signal B_{α, β}. In an event that an obstruction is present on an inside surface of the liner tube 30a, a pulse corresponding to the obstruction will be observed before the pulse 620. Moreover, in an event that the liner tube 30a is cracked or fractured, reflections forming the pulses 620, 630 will be confused, namely a convoluted and attenuated mixture of reflected radiation components.

In the first passive mode of operation of the system 300, spectral analysis, for example executed using a form of fast Fourier transform, of acoustic radiation generated by fluid flow through leakage holes and around an exterior of the liner tube 30a enables certain categories of defects to be detected. Conversely, when fluid flow is not occurring within the borehole 10, the second active mode of operation enables other types of defects to be identified. As elucidated in the foregoing, the system 300 is capable of being optimized for operating solely in either the first passive mode or solely in the second active mode. Alternatively, the system 300 is capable of being implemented to be able to function in both the first passive mode and the second active mode; for example, the system 300 is capable of being implemented to dynamically switch between the first and second modes in real-time when making measurements within the borehole 10.

Optionally, in order to reduce a quantity of data to be communicated via the communication link 120 when the system 300 is operating in the second active mode, the digital signal processor 310 is optionally configurable from the data processing arrangement 110 to analyze the signal F_{α, β} to identify times tₚ when reflection pulses, for example the pulse 620, 630, occur after their corresponding excitation burst of pulses 600 or single excitation pulse, and to determine their corresponding amplitudes U. and then communicate time of reflected pulse information tₙ and corresponding amplitude U as descriptive parameters via the communication link 120 to the data processing arrangement 110, thereby achieving potentially considerable data compression in comparison to communicating the signal F_{α, β} directly to the data processing arrangement 110; a rate at which the probe assembly 100 is capable of being advanced along the borehole 10 is thereby potentially considerably enhanced in real-time when data compression is utilized. As an alternative to communicating via the communication link 120, such parametric data is susceptible to being stored in the data memory 150 in FIG. 3 for subsequent downloading to the data processing arrangement 110 for data analysis to be performed at a later instance.

Operation of the data processing arrangement 110 will now be further elucidated. When data is communicated from the probe assembly 100 via the communication link 120 to the data processing arrangement 110, the processing arrangement 110 is optionally operable to record the received data from the probe assembly 100 as a data log in the data memory 140. Such a record enables, for example, subsequent analysis to be performed after the probe assembly 100 has been extracted from the borehole 10, for example to perform noise reduction operations for increasing a certainty of detection of various types of defects in the borehole 10. The data processor 330 is operable to execute one or more software products which apply further analysis and conditioning of data received via the communication link 120 from the probe assembly 100.

In real-time, when the system 300 is functioning in the second mode of operation, the data processor 330 presents, for example, on the two-dimensional display 130 a local perspective 3-dimensional representation of an interior of the borehole 10 substantially at a depth z at which the probe assembly 100 is positioned within the borehole 10, for example referring to FIGS. 2, 3 and 6 for a definition of the depth z; in FIG. 6, increasing depth z is in an upward direction in the drawing. Such representation on the display 130 in the second active mode of operation enables the one or more users 450 to visually spatially inspect the inside surface of the liner tube 30a in real-time. Time instances of receipt, for example, of the reflected pulses 620, 630 at the one or more transducer arrays 320 provides an indication of the spatial location of the inside and outside surfaces of the liner tube 30a and also potentially an ultrasonic radiation view of material surrounding an exterior of the liner tube 30a.

Alternatively, in the first passive mode of operation of the system 300, there is provided presented on the display 130 an indication of potential defects or ultrasonic noise sources as a function of the depth z and the angles α, β, see FIG. 6. A different type of presentation is then optionally provided on the display 130 illustrating identified defect and/or noise type as a function of radial position as defined by the angles α, β, and the depth z.

When the system 300 is configured to function in the second active mode, the data processor 330 employs one or more software products which operate to map the signal B_{α, β} by a mapping function M to a Cartesian or a polar coordinate data array, namely w (x, y, z) or w (α, β, z), as denoted as a mapping step 700 in FIG. 8 and described by Equation 4 (Eq. 4):

w(x,y,z)=M(B_{α,β},z)

w(α,β,z)=M(B_{α,β},z) Eq. 4

Values stored in elements w of the data array correspond to strength of reflected ultrasonic radiation, namely aforementioned magnitude U. as determined from reflection pulse peak amplitude in the signal B_{α, β}.

The signal B_{α, β}, for example as illustrated in FIG. 7b, is optionally communicated to the data processing arrangement 110 in data-compressed in a parameterized form as elucidated earlier. By action of the mapping function M, the data array w thereby has stored therein a spatial crude 3-dimensional image of an inside view of the borehole 10 wherein an array element w position is equivalent to a corresponding spatial position within the borehole 10.

Thereafter, in a gradient computation step 710, the data processor 330 is operable to apply a gradient-determining function to determine 3-dimensional gradients in element w signal amplitude values stored in the data array w (x, y, z) or w (α, β, z) namely to determine whereat spatial boundaries between features are present in the ultrasonic image of the borehole 10 recorded in the data array w. Identification of spatial boundaries is also known as “iso-surface extraction” in the technical art of image processing and involves computation of partial differentials of the array elements w as provided in Equation 5 (Eq. 5):

$$\frac{\partial w}{\partial x} , \frac{\partial w}{\partial y} , \frac{\partial w}{\partial z} \\ or \\ \frac{\partial w}{\partial α} , \frac{\partial w}{\partial β} , \frac{\partial w}{\partial z} \qquad Eq . 5$$

depending upon whether Cartesian or polar coordinate systems are employed.

In a step 720, the one or more software products are then operable to enhance values in the data array w, for example by curve fitting techniques, to show more clearly whereat continuous boundaries occur in the elements w (x, y, z) or w (α, β, z) stored image data store in the data memory of the data processor 330. Such curve fitting operations offer a smoothing function so that images presented on the display 130 are not cluttered with irrelevant surface texture details, but nevertheless show relevant features regarding integrity and operation of the borehole 10. Optionally, a step of smoothing is alternatively performed before a step of extracting iso-surfaces is performed.

Thereafter, in a step 730, the data processor 330 is operable to read data from the element w of the data array and then write corresponding presentation values, after geometrical transformation when necessary, into a memory buffer serving the display 130.

Optionally, in an event that the one or more software products executing on the data processor 330 identify when extrapolating one or more boundaries in the image stored in the elements w of the data memory to be unclear, the data processor 330 is then operable in real-time to instruct, as denoted by 740, the digital signal processor 310 for specific values of the angles α, β to repeat measurements within the borehole 10 for resolving such lack of clarity in the image stored at the data processor 330. Such instruction to the digital signal processor 310 optionally includes one or more of:
(a) causing the probe assembly 100 to employ its digital signal processor 310 to appropriately phase shift and scale pursuant to Equations 1 and 2 (Eqs. 1 and 2) more of its electrical signals Sᵢ to generate corresponding values of the signal B_{α, β} thereby having greater directional definition and resolution, the signals B_{α, β} being subsequently communicated to the data processing arrangement 110 for further data processing and subsequent presentation on the display 130;
(b) averaging, namely filtering, over numerous samples of the signal Sᵢ to reduce noise for a limited range of specified angular sensing directions defined by the angles α, β, and than computing corresponding signals B_{α, β} for communicating via the communication link 120 to the data processing arrangement 110 for subsequent further data processing thereat and thereafter presentation on the display 130;
(c) driving the transducer array 320 in the manner of a phased array so that more of its ultrasonic radiation 400 is delivered into a particular direction in which metrology and monitoring was previously unclear, acquiring further vales of the signal Sᵢ and subsequently computing corresponding signals B_{α, β} for communication to the data processing arrangement 110 for further data processing at the data processing arrangement 110 and thereafter presentation on the display 130; and
(d) acquiring a larger set of measurements over a given defined limited range of angles α, β so as to map out finer details of a feature present in the borehole 10, processing corresponding acquired signals Sᵢ to generate corresponding signals B_{α, β}, communicating the signals B_{α, β} via the communication link 120 to the data processing arrangement 110 for further data processing and eventual presentation on the display 130.

Beneficially, one or more of the users 450 as well as the data processing steps as illustrated in FIG. 8 are able to invoke a reconfiguration of the probe assembly 100 to acquire enhanced information from one or more regions of the borehole 10. After the enhanced information is acquired by the system 300, the system 300 is beneficially operable to revert back to its previous configuration state to continue monitoring the borehole 10. Thus, during monitoring operations involving maneuvering the probe assembly 100 of the system 300 along the borehole 10, the system 300 is optionally set to perform a method comprising steps of:
(a) performing a series of spatially coarse measurements along the borehole 10 whilst monitoring in real-time for any trace of one or more defects or other unusual features in the borehole 10;
(b) detecting one or more potential defects or other unusual features at a location along the borehole 10 in real-time;
(c) reconfiguring the probe assembly 100 to perform a selective more detailed series of measurements of the one or more defects or other unusual features; and
(d) after executing the more detailed series of measurements in step (c), resuming the series of spatially coarse measurements along the borehole 10 as in step (a).

This method is capable of being employed when the system 300 is operating in its first passive mode or in its second active mode. Optionally, the system 300 is beneficially operable to dynamically switch in real-time between the first and second modes when performing the series of spatially coarse measurements along the borehole 10.

The one or more transducer arrays 320 are described briefly in the foregoing. These one or more arrays 320 will now be described in greater detail. When the probe assembly 100 is required to provide spatial monitoring within the borehole 10 using ultrasonic radiation, the probe assembly 100 is beneficially operable to assist with providing at least one of: sideways monitoring, downwards monitoring. Such sideways monitoring is beneficially provided using a first side-looking transducer assembly indicated generally by 1000 in FIG. 9, and shown in external view in FIG. 10; there is provided a cross-sectional view of the first transducer assembly 1000. The first transducer assembly 1000 includes a circularly-symmetrical metallic body component 1010 and a circularly symmetrical metallic end cap 1020 retained in operation to the body component 1010 by a central threaded bolt 1030. A head of the bolt 1030 is included within a cavity 1035 formed in the body component 1010; a threaded portion of the bolt 1030 binds into a thread 1040 formed in the end cap 1020 to hold the body component 1010 and the end cap 1020 firmly attached together in operation. Moreover, the end cap 1020 has a conical external end surface 1042.

The body component 1010 and the end cap 1020 are operable to retain between them an ultrasonic transmission window 1045, and one or more piezo-electric elements 1058 disposed in a ring formation behind the transmission window 1045 as illustrated. Material of the transmission window 1045 is formed as a frusto-conical component having radially parallel inside and outside surfaces 1048, 1050 respectively. The body component 1010 and the end cap 1020 include peripheral lips 1100, 1110 respectively for retaining the ultrasonic transmission window 1045 in position. The inner and outer surfaces 1048, 1060 subtend an angle θ in a range 10° to 35° relative to a central longitudinal central axis 1055 of the probe assembly 100; more beneficially, the angle θ is in a range of 20° to 23°, and yet more beneficially substantially 23°. A flexible nitrile or similar robust material O-ring 1060 is included between the piezo-electric elements 1058 and an upper surface of the body component 1010 to provide a fluid seal for the bolt 1030. Moreover, the piezo-electric elements 1058 are fabricated so that their peripheral outward-facing frusto-conical surfaces have a profile which matches that of the inside surface 1048 of the transmission window 1046.

The first transducer assembly 1000 provides a benefit in operation that the end cap 1020 and the body component 1010 protect the transmission window 1045 from impact damage whilst providing the piezo-electric elements 1058 with an advantageous sideways view of the borehole 10 by way of transducing acoustic radiation. Moreover, the transmission window 1045 at least partially protects the piezo-electric elements from hydrolysis, corrosive chemicals and mechanical damage. Furthermore, inclusion of the bolt 1030 enables the transducer assembly 1000 to be dismantled for maintenance purposes, for example exchange of the piezo-electric elements 1068. Additionally the end cap 1020 is also capable, if required, of functioning as a heat sink for dissipating energy occurring within the piezo-electric elements 1058 when excited to generate the radiation 400. Beneficially, the cavity 1035 serves to ultrasonically isolate the transducer assembly 1000 from other regions of the probe assembly 100 so that spurious reflections are not reflected back to the first transducer assembly 1000 from these other regions of the probe assembly 100; the cavity 1035 provides an abrupt acoustic radiation step which results in ultrasonic radiation generated by the transducer assembly 1000 being confined to the transducer assembly 1000 and an external region therearound in the bore hole 10 when in use. Beneficially, the piezo-electric elements 1058 are designed to operate in a frequency range of 500 kHz to 5 MHz, more optionally in a wide frequency band centred on a centre frequency of substantially 3.5 MHz.

The end cap 1020 and the body component 1010 have an exterior diameter D in a range of 50 mm to 100 mm, optionally in a range of 60 mm to 70 mm. Moreover, the end cap 1020 beneficially has a radial length in a range of 30 mm to 60 mm, more optionally substantially 40 mm. Furthermore, the transmission window 1045 beneficially has a thickness between its inside and outside surfaces 1048, 1050 in a range of 1 mm to 5 mm, more beneficially in a thickness in a range of 2 mm to 3 mm. However, it will be appreciated that the first transducer assembly 1000 is susceptible to being manufactured in example dimensions described here for other application within borehole installations.

Whereas the first transducer assembly 1000 when employed as a part of the one or more transducer arrays 320 is highly effective for use in monitoring, for example, an inside surface of the liner tube 30e. for example for holes or cracks therein, it is not suitable for performing spatial monitoring directly down the borehole 10, for example for detecting an obstruction therein.

Referring to FIG. 11, there is shown an alternative second transducer assembly indicated generally by 2000. The second transducer assembly 2000 includes a body component 2010 including an annular recess 2020 to accommodate one or more piezo-electric elements 2030. The recess 2020 includes a nitrile O-ring 2040 and a cavity 2050 constituting an abrupt acoustic impedance step to reduce coupling of ultrasonic radiation to other regions of the probe assembly 100. The transducer assembly 2000 further includes an annular acoustic lens 2100 of a generally concave profile as illustrated, for example having an inwardly angled frusto-conical exterior surface 2110 as illustrated; the frusto-conical surface 2110 beneficially has an angle in a range of 20° to 45° relative to a central longitudinal axis 2105 of the transducer assembly 2000. A central portion 2120 of the lens 2100 is provided with a generally flat profile and optionally provides for accommodating a bolt 2130 for retaining the lens 2100 firmly attached to the body component 2010 in use. A peripheral exterior surface of the lens 2100 is protected within the body component 2010 and includes nitrile sealing O-rings 2140 to resist fluids present in the borehole 10 penetrating to the piezo-electric elements 2030.

In operation, the frusto-conical surface 2110 when excited by the piezo-electric elements 2030 results in certain portions of fluid immediately in front of the transducer assembly 2000 in operation being excited by way of acoustic radiation which propagates in a downwards direction near the central axis 2105. By varying relative phase and amplitude of drive signals S_{d} applied to the second transducer assembly 2000, it is possible to steer a generally downwardly-projected beam of acoustic radiation for interrogating the borehole 10.

Moreover, it is similarly possible to steer by such selective phase shifting and amplitude scaling of the signals 360 generated by the second transducer assembly 2000 a direction in which the second transducer assembly 2000 is most sensitive to the received acoustic radiation 350.

The transducer assembly 2000 beneficially has an exterior diameter in a range of 40 mm to 80 mm, more beneficially substantially 60 mm. Moreover, the transducer assembly 2000 is susceptible to being fabricated in other dimensions. Electrical connections to piezo-electric elements 1058, 2030 are provided but are not illustrated in FIGS. 9 and 11 for clarity.

The first and second transducer assemblies 1000, 2000 respectively are optionally susceptible to be combined together to provide a combination transducer array which is operable to monitor in a sideways direction in the borehole 10 as well as down the borehole; for example, the and cap 1020 of the first transducer assembly 1000 is modified to include the second transducer assembly 2000.

The transducer assemblies 1000, 2000 are optionally provided in a range of 1 to 500 elements, and more beneficially in a range of 20 to 300 elements when employed for spatial monitoring of the borehole 10.

In general, the probe assembly 100 beneficially has an exterior diameter “d” in a range of 50 mm to 180 mm, more beneficially a diameter in a range of 120 mm to 160 mm, and most beneficially substantially a diameter of substantially 150 mm. Moreover, the probe assembly 100 beneficially has a longitudinal length “L”, disregarding attachment of the cladding 200 and its associated communication link 120, in a range of 0.5 metres to 5 metres, more beneficially in a range of 1 metre to 3 metres and beneficially substantially 1.5 metres.

The system 300 is capable of being adapted to perform one or more of the following functions:
(a) Well leak detection, wherein the system 300 is operable to function as a Well Leak Detector (WLD). Leak depth accuracy to within an order of a centimetre (cm) is feasible. Moreover, leak rates in a range of 0.02 litres/minute to 300 litres/minute are susceptible to being detected and monitored by using the system 300; leak detection in production packers, expansion joints, tubing, down-borehole 10 safety valves, one or more casings in a well associated with the borehole 10, and in a wellhead associated with the borehole 10 are susceptible to being monitored using the system 300; in operation, it is often not necessary when using the system 300 in the borehole 10 to pull drill-string tubing up for identifying and monitoring a failing barrier in a well;
(b) Well sand detection, wherein the system 300 is operable to function as a Well Sand Detector (WSD). Sand is probably a biggest challenge to operators in the oil industry. Sand fills up the borehole 10 and chokes back productivity of the borehole 10 when used for oil extraction. Sand erodes well equipment and facilities, causing breakdown and sometimes causing blowouts. The system 300 is susceptible to being used to identify sand-producing regions of geological strata, namely sand-producing intervals, and is also susceptible to being used to identify failures in sand control devices employed in conjunction with sand control for the borehole 10 when used to extract oil. Beneficially, the probe assembly 100 is implemented such that its housing has a relatively smaller diameter, for example in a range of 40 mm to 80 mm, when adapted specifically for well sand detection. Acoustic energy is generated in the housing when sand particles impact upon the casing when the probe assembly 100 is in use, wherein the acoustic energy has a characteristic frequency spectrum by which the sand can be identified; at least a portion of the transducer array 320 is then specifically adapted for sensing such acoustic radiation resulting from sand impact on the probe assembly 100;
(c) Well flow detection, wherein the system 300 is operable to function as a Well Flow Detector (WFD); the system 300 configured to function as a well flow detector is susceptible in operation to providing detailed information about an inflow profile from the borehole 10 when used for oil extraction, for example for providing relative velocity profiles between different producing or injecting intervals of the borehole 10, for example those intervals which are not contributing at all to oil extraction; and
(d) Well annular flow detection, wherein the system 300 is operable to function as a Well Annular Flow monitor (WAF); the system 300 operable as the Well Annular Flow monitor is capable of detecting and locating flow behind a pipe in an annulus between a liner tube, namely casing, and a geological formation; the system 300 is thereby operable to detect contamination of groundwater, one or more underground blowouts, sustaining liner tube pressure, one or more undesirable water cuts, and one or more undesirable gas cuts when drilling the borehole 10.

The system 300 is optionally optimized to perform one of functions (a) to (d). Alternatively, the system 300 can be optimally designed to perform several of these functions and to dynamically switch between such functions when in use. Certain of the functions (a) to (d) are serviced in the aforementioned first passive mode, whereas other of the functions (a) to (d) are addressed by the system 300 operating in its second active mode. In general, a cost and complexity of the system 300 increases as it is required to be more versatile in dynamically performing diverse functions.

It will be appreciated that embodiments of the invention as described in the foregoing are susceptible to being modified without departing from the scope of the invention as defined by the appended claims.

Beneficially, the probe assembly 100 is furnished with one or more pressure sensors for measuring a pressure P present within the borehole 10 as the probe assembly 100 is manoeuvred in operation along the borehole 10. In an event that the probe assembly 100 detects that the pressure P in the borehole 10 becoming excessive, for example in excess of 500 Bar, the probe assembly 100 is operable to transmit a warning message to the one or more users 450.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Numerals included within parentheses in the accompanying claims are intended to assist understanding of the claims and should not be construed in any way to limit subject matter claimed by these claims.

1-12. (canceled)

13. A petroleum production well ultrasound logging tool comprising a cylindrical main body having a lower end holding a sideways monitoring transducer assembly comprising a ring-shaped ultrasound transducer array of piezo-electric transducer elements, said transducer array having a downward tapering frustoconical shape,
said ultrasound transducer array's radially outward face covered by a funnel shaped acoustic window with a radially inward facing surface corresponding to said outward face,
said ultrasound transducer array and said acoustic window retained on said cylindrical main body's lower end by an end cap.

14. The petroleum production well ultrasound logging tool of claim 13, said end cap retained on a bolt extending from said main body.

15. The petroleum production well ultrasound logging tool of claim 13, comprising a flexible ring arranged between said main body and said ultrasound transducer array.

16. The petroleum production ultrasound logging tool of claim 13, said funnel-shaped window having an outer surface which is parallel with said inner surface.

17. The petroleum production ultrasound logging tool of claim 13, said main body and said end cap comprising peripheral lips respectively for retaining said ultrasonic window in position.

18. The petroleum production ultrasound logging tool of claim 13, said ultrasound window's inner and outer surfaces subtending an angle in the range of 10 to 35 degrees relative to a central longitudinal axis of the tool.

19. The petroleum production ultrasound logging tool of claim 13, said ultrasound window's inner and outer surfaces subtending an angle in the range of 20 to 23 degrees relative to a central longitudinal axis of the tool.

20. The petroleum production well ultrasound logging tool of claim 13, said ultrasound transducer array's elements arranged for operating at a frequency of 500 kHz to 5 MHz.

21. The petroleum production well ultrasound logging tool of claim 13, the diameter of the main body being 50 mm to 100 mm, and the end cap and main body is slightly wider than the frustoconical-shaped transducer array.

22. The petroleum production well ultrasound logging tool of claim 13, the transmission window having a thickness between its inside and outside surfaces in a range of 1 mm to 5 mm.

23. The petroleum production well ultrasound logging tool of claim 13, two or more of said ultrasound transducer array's elements arranged for transmitting as a phased array for beam-forming the transmitted ultrasound wave by selectively phase shifting and scaling the signals sent to the transducers.

24. The petroleum production well ultrasound logging tool of claim 13, receiving ultrasound energy at said transducer array's elements and beam-forming the received ultrasound signals to obtain a component of radiation received at the transducer array from a specific direction.

25. The petroleum production well ultrasound logging tool of claim 24, the number (i) of consecutive transducer elements' signals in said beam-forming being at least 15.

26. The petroleum production well ultrasound logging tool of claim 13,
beam forming the transmitted ultrasound signals in that said transducer elements arranged for being excited by selectively phase shifted drive signals to generate ultrasonic radiation and for receiving ultrasonic radiation and generating received electrical signals, and
beam forming the received ultrasound signals by selectively summing signals representing received signals received at the transducer array from a specific direction, by scaling and phase-shifting and combining a number (i) of at least 10 to 15 received signals to generate a received signal (B).

27. The petroleum production well ultrasound logging tool of claim 13, said ultrasound transducer elements arranged for emitting ultrasound signals in the form of bursts of pulses having a pulse repetition frequency.

28. The petroleum production well ultrasound logging tool claim 13, arranged for receiving reflected pulses from an inner face of a liner tube, and further for resolving ultrasound components reflected from an exterior facing surface of a liner tube surrounding said transducer array.

29. The petroleum production well ultrasound logging tool of claim 13, further arranged for monitoring and locating flow in an annulus between a liner tube and a geological formation.
